(19) United States
(12) Patent Application Publication
(10) Pub. No.: US 2025/0091772 A1
(43) Pub. Date: Mar. 20, 2025

(54) ION RELEASE OF ORAL CARE COMPOSITIONS AND RELATED NOZZLES, ASSEMBLIES, AND METHODS

(71) Applicant: The Procter & Gamble Company, Cincinnati, OH (US)

(72) Inventors: Tiffany Celeste HARE, West Chester, OH (US); Phillip Asa DRAKE, Mason, OH (US); Jeremy Clay CHRISTMAN, Liberty Township, OH (US)

(21) Appl. No.: 18/816,452

(22) Filed: Aug. 27, 2024

Related U.S. Application Data
(60) Provisional application No. 63/651,064, filed on May 23, 2024.
(60) Provisional application No. 63/582,609, filed on Sep. 14, 2023.
(60) Provisional application No. 63/582,606, filed on Sep. 14, 2023.

(51) Int. Cl. B65D 35/38; B65D 47/08

(52) U.S. Cl. CPC B65D 35/38; B65D 47/08

(57) ABSTRACT

A method for using an oral care composition includes dispensing the oral care composition through a nozzle to form a dispensed composition. The nozzle includes an orifice having a central axis and an orifice diameter, and fins partially occluding the orifice. The method also includes brushing teeth with the dispensed composition to form a slurry. The dispensed composition has a faster ion release during brushing compared to a control dispensed composition made by dispensing the oral care composition through a control nozzle comprising an unobstructed, circular orifice having the orifice diameter.

### TECHNICAL FIELD

The disclosure relates generally to the improved ion release of oral care compositions and, more particularly, relates to nozzles, assemblies, and methods for dispensing an oral care composition with improved ion release.

### BACKGROUND

Oral care compositions, such as toothpaste and/or dentifrice compositions, can be applied to the oral cavity to clean and/or maintain the aesthetics and/or health of the teeth, gums, and/or tongue. Additionally, many oral care compositions are used to deliver active ingredients directly to oral care surfaces. Using the right amount of the oral care composition ensures that you have the right amount of active ingredients to provide effective cleaning and removal of plaque, food particles, and bacteria, promoting optimal oral hygiene. For example, many toothpastes contain fluoride, which helps strengthen tooth enamel and prevent tooth decay. Using the recommended amount of toothpaste and brushing teeth for a recommended length of time helps ensure that the user receives the benefit of an effective dose of fluoride and/or the intended amount of aesthetic ingredients (e.g., flavor).

Many commercial toothpaste packages have a flexible tube to contain the toothpaste and a cylindrical nozzle. When a user squeezes the flexible tube, toothpaste is extruded through the cylindrical nozzle and dispensed in the form of a nurdle onto a toothbrush head. Users often apply less toothpaste to their brushes than the recommended dose. Additionally, many users brush their teeth for less time than the recommended time. There is a need for devices or methods for improving the delivery of ingredients without requiring the user to change habits.

### SUMMARY

In an embodiment, a method for using an oral care composition is provided. The method includes dispensing the oral care composition through a nozzle to form a dispensed composition. The nozzle includes an orifice having a central axis and an orifice diameter, and fins partially occluding the orifice. The method also includes brushing teeth with the dispensed composition to form a slurry. The dispensed composition has a faster ion release during brushing compared to a control dispensed composition made by dispensing the oral care composition through a control nozzle comprising an unobstructed, circular orifice having the orifice diameter.

In an embodiment, a method for using an oral care composition is provided. The method includes dispensing the oral care composition through a nozzle to form a dispensed composition. The nozzle includes an orifice having a central axis and an orifice diameter and fins partially occluding the orifice. The method also includes adding the dispensed composition to a liquid and forming a slurry of the dispensed composition and the liquid. The dispensed composition has a faster ion release in the slurry compared to a control dispensed composition made by dispensing the oral care composition through a control nozzle comprising an unobstructed, circular orifice having the orifice diameter.

### BRIEF DESCRIPTION OF THE DRAWINGS

While the specification concludes with the claims particularly pointing out and distinctly claiming the invention, it is believed that the present invention will be better understood from the following description taken in conjunction with the accompanying drawings in which:

FIG. 1 is a top view of an example embodiment of a nozzle.

FIG. 2 is a perspective view of the nozzle of FIG. 1.

FIG. 3 is a side view of the nozzle of FIG. 1.

FIG. 3A is a cross-sectional view of the nozzle of FIG. 1 taken along the line 3A-3A in FIG. 3.

FIG. 4 is a perspective view of an example embodiment of a nozzle.

FIG. 5 is a top view of the nozzle of FIG. 4.

FIG. 6 is a perspective view of an example embodiment of a nozzle.

FIG. 7 is a top view of the nozzle of FIG. 6.

FIG. 8 is a perspective view of an example embodiment of a flip-top style cap.

FIG. 9 is a perspective view of an example embodiment of a tube.

FIG. 10 is a chart showing the percent of theoretical fluoride ion release into solution over time during mixing of a dentifrice extruded through a comparative nozzle and an inventive nozzle.

FIG. 11 is a chart showing the area under the curve (AUC) for the first 30 seconds of the results shown in FIG. 10.

FIG. 12 is a chart showing the percent theoretical ion release over time for a comparative nozzle and an inventive nozzle over time.

FIG. 13 is a chart showing the numerical difference of the percent theoretical ion release of FIG. 12 over time.

FIG. 14 is a chart showing the rate of change of the percent theoretical ion release of FIG. 12 over time.

FIG. 15 is a chart comparing the AUC at 30 seconds versus the occluded area of the comparative nozzle and various inventive nozzles.

FIGS. 16A-16E are perspective, side, cross-sectional, top, and bottom views, respectively, of a comparative nozzle.

FIGS. 17A-17E are perspective, side, cross-sectional, top, and bottom views, respectively, of a comparative nozzle.

FIGS. 18A-18E are perspective, side, cross-sectional, top, and bottom views, respectively, of an inventive nozzle.

FIGS. 19A-19E are perspective, side, cross-sectional, top, and bottom views, respectively, of an inventive nozzle.

FIG. 20 is a chart comparing the average fluoride ion release at 30 seconds for the nozzles of FIGS. 16A, 17A, 18A, and 19A.

FIG. 21 is a chart showing the percent of theoretical fluoride ion release from three dentifrices into solution over time for a comparative nozzle and an inventive nozzle.

FIG. 22 is a chart showing the percent of theoretical fluoride ion release from three dentifrices after 30 seconds for the inventive nozzle.

FIG. 23 is a chart showing the mV measurement of a slurry over time during mixing of a dentifrice extruded through a comparative nozzle and an inventive nozzle.

FIG. 24 is a chart showing the percent change in mV over time during mixing of a dentifrice extruded through a comparative nozzle and an inventive nozzle.

FIG. 25 is a chart showing the pH over time during mixing of a dentifrice extruded through a comparative nozzle and an inventive nozzle.

### DETAILED DESCRIPTION

Embodiments of the present invention are directed to a partially occluded nozzle that, in use, provides improved nurdle weight. The nozzle may also provide an improved aesthetic experience, an improved sensory experience, and improved rate of ingredient or ion release of the dispensed oral care composition for the user. Embodiments of the present invention are also directed oral care assemblies comprising a nozzle and a tube as well as methods of making and using such an assembly.

The shape of the nozzle orifice has been discovered to impact toothpaste nurdle output in multiple ways. Modifying the way in which the oral care composition exits the tube has significant impacts on both physical nurdle and consumer sensory experience. For example, creating multiple separate strips at the orifice that join together to form the nurdle on the toothbrush head increases the surface area of the resulting nurdle. This in turn provides an aesthetic benefit by changing the nurdle shape from a simple cylinder to an aesthetic swirl. Additionally, or alternatively, shearing of the oral care composition upon dispensing to the toothbrush, immediately prior to brushing, appears to impact the sensory experience significantly in that it improves dispersibility, increases flavor display, and increases foaming. Without wishing to be bound by theory, it is believed that the shearing, pressurization, off-axis extrusion, alone or in combination, may result in an increase in nurdle weight as discussed further below. Thus, a nozzle according to an embodiment of the present invention can enhance the appearance of the nurdle, increase the size and surface area of the oral care composition that is dispensed, and positively impact the consumer experience of dispersibility, flavor, and foamability. These changes may be aesthetically pleasing and deliver an amount of the oral care composition that is closer to the recommended dose. These changes may also provide an improved experience if the user brushes for less than the recommended time by releasing the ingredients faster during brushing. The improvements in paste characteristics and brushing experience are due to the interaction of the oral care composition with the partially occluded orifice.

Although the following detailed description is given primarily in the context of a nozzle and tube for containing a dentifrice product, it will be understood that the nozzle or tube may be useful for containing and dispensing other oral care or personal care products where it is desirable to provide an increased amount of product, an improved sensory experience, or improved ion release or dissolution compared to a conventional circular orifice.

The section headers below are provided for organization and convenience only.

### Definitions

To define more clearly the terms used herein, the following definitions are provided. Unless otherwise indicated, the following definitions are applicable to this disclosure. If a term is used in this disclosure but is not specifically defined herein, the definition from the IUPAC Compendium of Chemical Terminology, 2nd Ed (1997), can be applied, as long as that definition does not conflict with any other disclosure or definition applied herein, or render indefinite or non-enabled any claim to which that definition is applied.

As used herein, “coupled” means “permanently coupled” or “releasably coupled.” The term “permanently coupled” is understood to refer to configurations in which a first element is secured to a second element such that the elements generally cannot be separated from one another without at least partially destroying one or both of the elements. The term “releasably coupled” is understood to refer to configurations in which a first element is secured to a second element, such that the first element and the second element can be separated with no or minimal damage to the first and second elements.

The term “oral care composition”, as used herein, includes a product, which in the ordinary course of usage, is not intentionally swallowed for purposes of systemic administration of particular therapeutic agents, but is rather retained in the oral cavity for a time sufficient to contact dental surfaces or oral tissues. Examples of oral care compositions include dentifrice, toothpaste, tooth gel, subgingival gel, emulsion, mouth rinse, mousse, foam, mouth spray, lozenge, chewable tablet, chewing gum, tooth whitening strips, floss and floss coatings, breath freshening dissolvable strips, unit-dose composition, fibrous composition, or denture care or adhesive product. The oral care composition may also be incorporated onto strips or films for direct application or attachment to oral surfaces, such as tooth whitening strips. Examples of emulsion compositions include the emulsions compositions of U.S. Pat. No. 11,147,753, jammed emulsions, such as the jammed oil-in-water emulsions of U.S. Pat. No. 11,096,874. Examples of unit-dose compositions include the unit-dose compositions of U.S. Patent Application Publication No. 2019/0343732.

The term “dentifrice composition”, as used herein, includes tooth or subgingival-paste, gel, or liquid formulations unless otherwise specified. The dentifrice composition may be a single-phase composition or may be a combination of two or more separate dentifrice compositions. The dentifrice composition may be in any desired form, such as deep striped, surface striped, multilayered, having a gel surrounding a paste, or any combination thereof. Each dentifrice composition in a dentifrice comprising two or more separate dentifrice compositions may be contained in a physically separated compartment of a dispenser and dispensed side-by-side.

“Active and other ingredients” useful herein may be categorized or described herein by their cosmetic and/or therapeutic benefit or their postulated mode of action or function. However, it is to be understood that the active and other ingredients useful herein can, in some instances, provide more than one cosmetic and/or therapeutic benefit or function or operate via more than one mode of action. Therefore, classifications herein are made for the sake of convenience and are not intended to limit an ingredient to the particularly stated function(s) or activities listed.

The term “substantially free” as used herein refers to the presence of no more than 0.05%, preferably no more than 0.01%, and more preferably no more than 0.001%, of an indicated material in a composition, by total weight of such composition.

The term “essentially free” as used herein means that the indicated material is not deliberately added to the composition, or preferably not present at analytically detectable levels. It is meant to include compositions whereby the indicated material is present only as an impurity of one of the other materials deliberately added.

The term “oral hygiene regimen” or “regimen” can be for the use of two or more separate and distinct treatment steps for oral health, e.g., toothpaste, mouth rinse, floss, toothpicks, spray, water irrigator, massager.

While compositions and methods are described herein in terms of “comprising” various components or steps, the compositions and methods can also “consist essentially of” or “consist of” the various components or steps, unless stated otherwise.

As used herein, the word “or” when used as a connector of two or more elements is meant to include the elements individually and in combination; for example, X or Y, means X or Y or both.

As used herein, the articles “a” and “an” are understood to mean one or more of the material that is claimed or described, for example, “an oral care composition” or “a bleaching agent.”

All measurements referred to herein are made at about 23° C. (i.e., room temperature) unless otherwise specified.

Several types of ranges are disclosed in relation to embodiments of the present invention.

When a range of any type is disclosed or claimed, the intent is to disclose or claim individually each possible number that such a range could reasonably encompass, including end points of the range as well as any sub-ranges and combinations of sub-ranges encompassed therein.

### Nozzle

The size and shape of the nozzle helps define a user's experience in dispensing a desired toothpaste volume from the package. A nozzle according to an embodiment of the present invention may provide multiple benefits. For example, the weight of the nurdle may be increased to help deliver an optimal dose of the oral care composition to the user. The oral care composition may be formulated to provide a particular amount of active ingredients (e.g., fluoride) and aesthetic ingredients (e.g., for flavor or foaming). The increased weight of the nurdle due to use of the improved nozzle may lead to superior foaming and flavor display, which may provide an enjoyable brushing experience and leave the mouth feeling clean and refreshed compared to using a smaller-than-recommended amount of the oral care composition. The superior foaming display may be, for example, an increased rate of foam generation during the early stages of brushing. The aesthetics of the nurdle may be improved with a swirled shape compared to a traditional cylindrical nurdle. The user may experience multiple differences during brushing due to the improved nurdle. Some examples include improved foamability, a sense that the oral care composition is lighter, more flavorful, and creamier, and improved rate of ingredient release into solution such that the active and aesthetic ingredients are more likely to be fully released before the end of the brushing event. The improved foamability may be, for example, an increased rate of foam generation during the early stages of brushing.

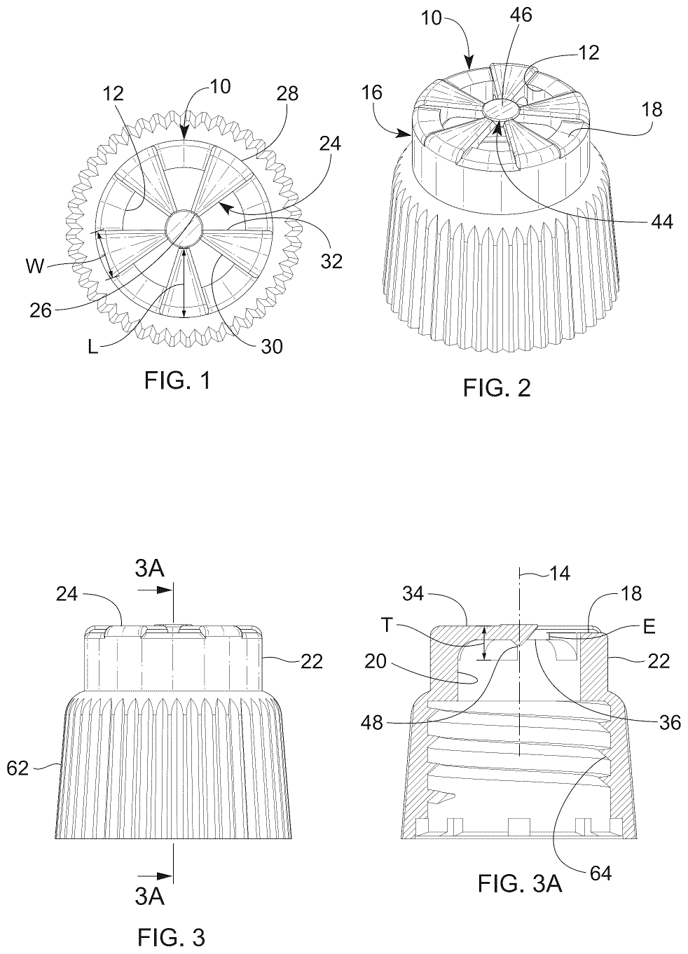

FIGS. 1-3A illustrate a nozzle 10 according to an embodiment of the present invention. In use, an oral care composition, such as a toothpaste, can be extruded through the nozzle orifice to an exterior of the nozzle 10 (e.g., onto a toothbrush) to create a nurdle. The nozzle 10 may include a nozzle orifice 12 having a central axis 14. The nozzle orifice 12 may be defined by a sidewall 16. The sidewall 16 may have a distal surface or rim 18, an inner surface 20, and an outer surface 22. The rim 18 may be on a plane orthogonal to the central axis 14 of the orifice 12. The rim 18 may be coplanar with the nozzle orifice 12. The thickness of the rim 18 can range from about 0.25 mm to about 4 mm or from about 0.5 mm to about 1.5 mm. The diameter of the orifice 12 may be about 8 mm, about 9 mm, about 10 mm, or may be from about 7 mm to about 11 mm, or from about 8 mm to about 10 mm, or from about 8.5 mm to about 10 mm.

The nozzle orifice 12 may be partially occluded, such as by one or more fins 24. The fins 24 may each extend from an inner end 26 to an outer end 28 and between a first side 30 and a second side 32. The fins 24 may also include an upper surface 34 and a lower surface 36. The fins 24 may be proximal of, distal of, or in line with the orifice 12. In an embodiment, the entire upper surface 34 of the fin 24 may be distal of the orifice 12, and the entire lower surface 36 may be proximal of the orifice 12. In an embodiment, the upper surface 34 may be flat or may be arched (see, e.g., FIG. 6). The lower surface 36 may be, for example, arched or flat (not shown).

The fins 24 may be in line with each other or, for example, one or more of the fins 24 may be more proximal or more distal of another fin 24. At least a portion of the fins 24 extend over the orifice 12 to partially occlude the orifice 12. The fins 24 may extend radially outward of the orifice 12 as well. For example, the outer end 28 of the fins 24 may extend to the edge of the rim 18 of the sidewall 16. As shown in FIGS. 2 and 3A, in an embodiment, the fins 24 may extend above and below (or proximal of and distal of) the orifice 12.

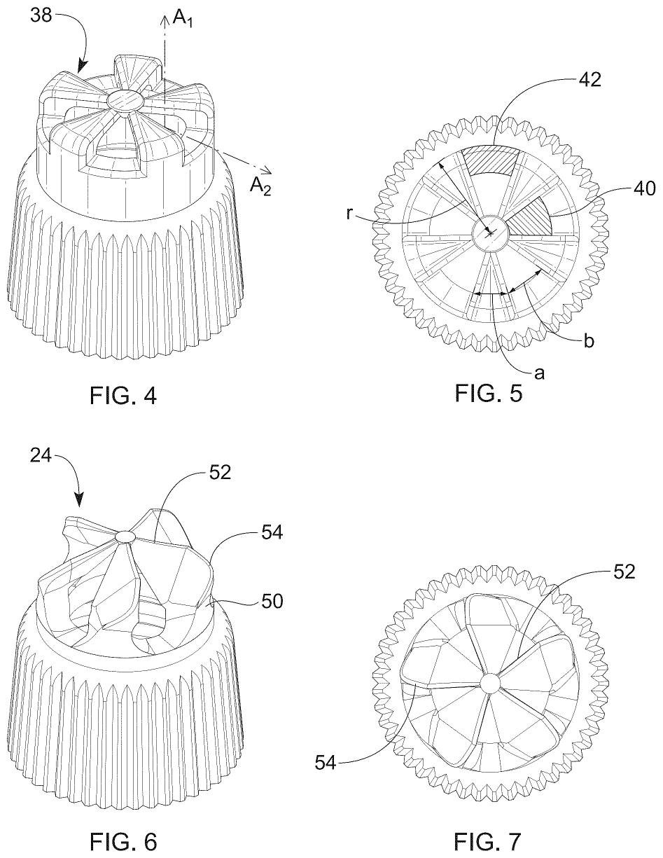

The fins 24 create openings 38 through which the oral care composition moves when being extruded through the nozzle 10. The openings 38 may be symmetrical or asymmetrical. As shown best in FIGS. 4 and 5, these openings 38 may include on-axis channels 40 and/or off-axis channels 42. The on-axis channel 40 is the space distal of the nozzle orifice 12 extending to a distal end of the fins 24. The off-axis channel 42 corresponds to the axially outside of the orifice 12 and extends to the outer ends of the fins 24. For example, in FIG. 5, the off-axis channel 42 extends from the rim 18 distally to a top of the fins 24, from the inner edge of the rim (the orifice 12) to the outer edge of the rim 18, and between the sides of the fins 24. When the oral care composition is extruded, the portion of the composition moving through the on-axis channels 40 are moving generally parallel to the central axis 14 of the orifice 12 (arrow A₁). Referring to FIG. 4, the off-axis channels 42 allow some of the extruded oral care composition to move axially away from the central axis 14 of the orifice 12 (arrow A₂). Extruding the oral care composition around the fins 24 and through the off-axis channels 42 both shears and pressurizes the flow of the oral care composition. It has been surprisingly found that the shear and pressurization may result in an increase in nurdle weight. Separately, product shear and reshaping appear to enhance and magnify flavor display, which provides an improved consumer experience when brushing with product extruded through this type of shaped orifice.

Referring to FIGS. 2 and 3A, in an embodiment, the nozzle 10 may include a hub 44 connecting the fins 24. In an embodiment, the hub 44 may be centered relative to the orifice 12 such that a longitudinal axis of the central hub 44 is coaxial with the central axis 14 of the orifice 12. The size and shape of the hub may vary. For example, an upper surface 46 of the hub 44 may be circular. The greatest diameter of the central hub 44 can range, for example, from about 0.5 mm to about 5 mm, from about 1 mm to about 4 mm, or from about 2.5 to about 3.5 mm. The central hub 44 may have a conical shape with a lower point 48, as shown best in FIG. 3A, to direct flow of the oral care composition and encourage side extrusion. In another embodiment, the central hub 44 may be cylindrical or may have a flat lower surface. Like the fins 24, the central hub 44 may be elevated relative to the orifice 12. The elevation may also encourage side extrusion of the oral care composition when dispensed. In an example, the upper surface 46 of the central hub 44 may be distal of the orifice 12, and the point 48 or lower surface of the central hub 44 may be proximal of the orifice 12. The central hub 44 may be in the same plane or a different plane as the fins 24. In another embodiment, the fins 24 may be spaced apart such that they do not touch each other (e.g., no central hub is present).

Several parameters, including fin width, thickness, and elevation relative to the orifice, have been found to impact the weight and aesthetics of the nurdle. Without wishing to be bound by theory, it is believed that reshaping the oral care composition as it is extruded by consumers produces an increase in effective nurdle diameter, which in turn increases the dose. Given that benefits such as caries prevention, whitening, cleaning, gingivitis reduction, breath freshening, etc., may be dose-dependent, this attribute provides an advantage for the consumer. This is particularly important when using a smaller toothbrush head, such as those found on most power brushes, where the available surface area on which the product may be dispensed is limited compared to most manual brush heads.

The off-axis extrusion area and the total orifice area that is restricted can vary. The off-axis extrusion area can range from 0 mm² to about 1 cm², 0 mm² to about 25 mm², from about 0 mm² to about 5 mm², or from about 3.9 to about 16.4 mm². In an embodiment where the fins are sector or pie-piece shaped, the off-axis extrusion area may be approximated by the product of: the number of fins (n), the distance that the top of the fin protrudes distally beyond the orifice, and the approximate width of the opening between fins (b). The maximum width of the opening between individual fins (b) can be approximated according to the following equation:

$$b = \frac{( 2 π r - a n )}{n}$$

where “r” is a radial distance from the center of the orifice to the outer circle defined by the ends of the fins, “n” is the number of fins, and “a” is the fin width at inner edge of orifice. FIG. 5 shows “r,” “a,” and “b” in an example embodiment. The off-axis extrusion area may be divided into low-pressure and high-pressure areas.

The total orifice surface area that is restricted (e.g., by the fins 24 and the optional hub 44) can range from about 10% to about 90%, from about 40% to about 60%, from 38.3% to about 58.9%, from about 44.6% to about 49.6%, from about 45% to about 50%, or about 46% to about 48% of the total orifice surface area.

The number of the fins 24 may vary. The nozzle 10 may include, without limitation, 1 fin, 2 fins, 3 fins, 4 fins, 5 fins, 6 fins, 7 fins, or more than 7 fins. The nozzle 10 may include, without limitation, from 1 to 10 fins, from 3 to 7 fins, or from 4 to 6 fins.

The length of the fins 24 may vary. The fins 24 may have the same length or may have different lengths. FIG. 1 shows the length, L, of a fin 24. In some embodiments, the length or greatest length of the fins 24 can range from about 1 mm to about 7 mm, from about 3.25 to about 4.5 mm, or from about 3.5 to about 4 mm.

The width of the fins 24 may vary. The fins 24 may have the same width or may have different widths. The width of the fins 24 may be constant or may vary along the fin 24. The variation in width of the fins may be constant or variable. For example, as shown in FIG. 1, the sides of the fins 24 are linearly tapered inward from a greatest width, W, towards the central hub 44. In another example, the sides of the fins 24 may bow outwardly or inwardly. In some embodiments, the width or greatest width of the fins 24 may be from about 0.5 mm to about 6 mm, from about 1 mm to about 5 mm, from about 3 mm to about 5 mm, from about 3.25 mm to about 4.5 mm, or from about 3.25 mm to about 4 mm.

The thickness of the fins 24 may vary. The fins 24 may have the same thickness or may have different thicknesses. The thickness of the fins 24 may be constant or may vary along the fin 24. For example, as shown in FIG. 3A, the thickness of the fins 24 decrease from a greatest thickness, T, towards the central hub 44. In some embodiments, the thickness or greatest thickness of the fins 24 can range from about 0.1 mm to about 10 mm, from about 0.25 mm to about 5 mm, from about 0.25 to about 2 mm, or from about 0.5 to about 1.5 mm.

The elevation of the fins 24 relative to the orifice 12 may vary. The elevation of the fins 24 may be measured from the lower surface 36 of the fin 24 to the rim 18 or, if a rim is not present, the distal-most edge of the orifice 12. FIG. 3A shows an elevation, E, of the fins 24. In some embodiments, the elevation or greatest elevation can range from about −5 mm to about 5 mm, from about −2 mm to +1 mm, from about −1 mm to about 0 mm, from about −0.5 to about 0 mm, from about 0 mm to about 0.5 mm. With reference to FIGS. 4 and 5, an example embodiment of a nozzle 10 is shown where the fins 24 are elevated above the nozzle orifice 12.

The shape of the fins 24 may vary. In another embodiment, the fins may have a triangular, rectangular, or curved shape or may be shaped like a fan blade or propeller. As shown in FIGS. 1 and 5, in an embodiment, the shape of the fins 24 may be a sector or pie-piece shape. The fins 24 may extend from the rim 18 over the orifice 12. The fins 24 may be coupled to the central hub 44. The fins 24 and central hub 44 may form a wagon wheel shape. In another embodiment, the fins 24 may be arched and coupled to the central hub 44 to form a dome shape (e.g., as shown in FIG. 6). In another embodiment, the fins 24 may have ends that are not coupled to another portion of the nozzle 10. In an embodiment not including a rim, the fins 24 may be coupled to the nozzle 10 adjacent an edge of the orifice 12 and extend distally of the orifice 12. The fins 24 may be inclined at an angle relative to a central axis 14 of the orifice 12 or may be at a right angle to the central axis 14 (as shown in FIGS. 2 and 3A).

Referring to FIGS. 6 and 7, in another embodiment, the shape of the fins 24 may be similar to a curved fan blade shape. For example, the fins 24 may have a longitudinal portion 50, an axial portion 52, and a transitional portion 54 therebetween. The longitudinal portion 50 may be coupled to the rim 18 and extend distally of the rim 18. In an embodiment not including a rim, the longitudinal portion 50 may be coupled to the nozzle 10 adjacent an edge of the orifice 12 and extend distally of the orifice 12. In the illustrated embodiment, the longitudinal portion 50 does not extend over the orifice 12. In another embodiment, the longitudinal portion 50 may extend over the orifice 12.

The axial portion 52 may extend towards the central axis 14 of the orifice. In other words, the axial portion 52 may extend over and partially occlude the orifice 12. The axial portion 52 may extend to the central hub 44 if present. In an embodiment where a central hub is not present, the end of the axial portion 52 may freely hang over the orifice 12 or may join with the axial portion 52 of another fin 24. The axial portion 52 may be inclined at an angle relative to a central axis 14 of the orifice 12. The inclination angle of the axial portion 52 may vary over a length of the axial portion 52. The inclination angle may be from about 0° to about 90°, between about 0° to about 60°, between about 15° to about 90°, between about 40° to about 50°, or may be about 0° or about 45°. In another embodiment, the axial portion 52 may be at a right angle relative to the central axis 14 of the orifice 12.

The transitional portion 54 extends between the longitudinal portion 50 and the axial portion 52. The transitional portion 54 may be curved and twisted. At least a portion of the transitional portion 54 may be inclined relative to a central axis 14 of the orifice 12. In various embodiments, the transitional portion 54 may partially occlude the orifice 12 or may not occlude the orifice 12.

Where the first and second sides 30, 32 of the fins 24 are not coplanar, the first and second sides 30, 32 may define a leading edge and a trailing edge, respectively. The trailing edge at the axial portion 52 may be distal of the leading edge at the axial portion 52. When being extruded through the nozzle, the oral care composition may first contact the leading edge before the trailing edge.

The width and thickness of the longitudinal portion 50, the axial portion 52, and the transitional portion 54 may vary. For example, a thickness of the transitional portion at the trailing edge may be greater than a thickness of the transitional portion at the leading edge. The thickness of the longitudinal portion 50 may be greater than the thickness of the end of the axial portion 52. Similarly, the width of the longitudinal portion 50 may be greater than the width of the end of the axial portion 52.

### Cap

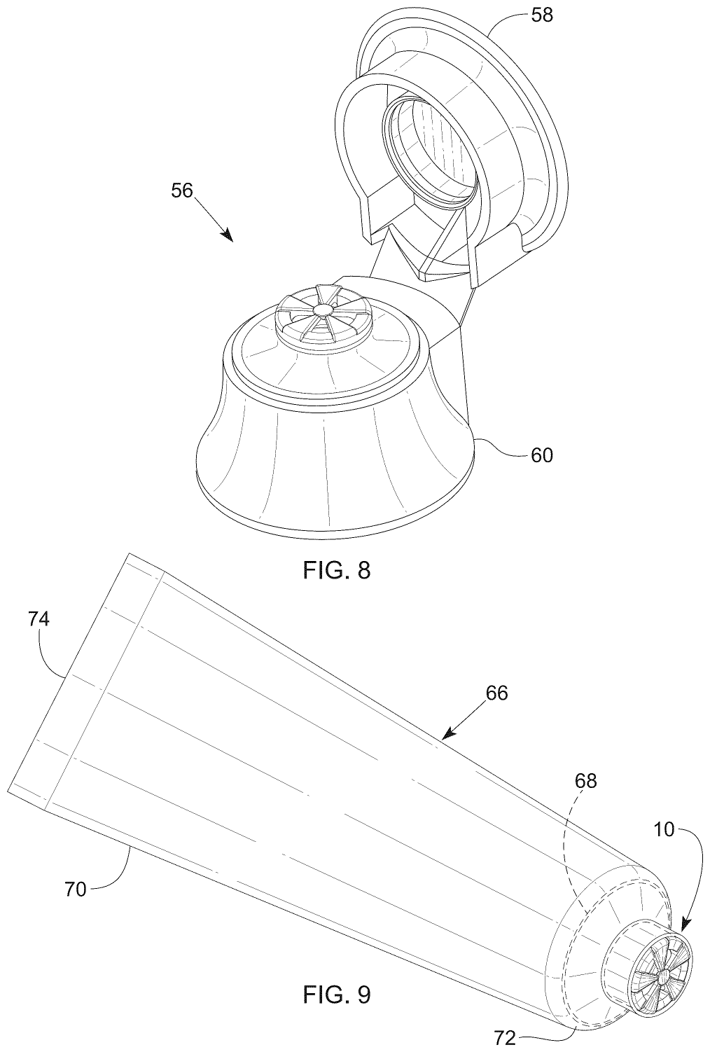

A nozzle, according to some embodiments, may be coupled to or integral with a cap. As shown in FIG. 8, in an embodiment, the cap may be a flip-top style cap 56 with a lid 58 that is hinged to the cap body 60. The cap body 60 may be configured to be releasably coupled with a container or tube.

The form of the cap may vary. The nozzle may act as a cap on a tube. The example nozzles shown in FIGS. 1-7 are depicted with a fez-style skirt extending proximally therefrom. For example, as shown in FIG. 3A, the skirt 62 may flare slightly outward from the nozzle 10 to a proximal end of the skirt 62. The outer surface of the skirt 62 may be smooth or may be textured, such as ridged. The skirt may be removably coupled with a tube, for example, using interior threads 64.

Alternatively, the nozzle may be separate from the cap. For example, the nozzle may be coupled to or integral with a tube, as discussed below. In such an embodiment, the cap may be a conventional cap, such as a screw-on style cap (e.g., a fez cap).

### Tube

An oral care assembly may include a tube, a nozzle, and a cap. FIG. 9 illustrates, according to an example embodiment, a reservoir or tube 66 and a nozzle, such as nozzle 10. The tube 66 may contain an oral care composition, such as a toothpaste. A longitudinal axis of the tube or assembly, the central axis 14 of the orifice 12, and a direction of flow of the oral care composition may be, for example, parallel or coaxial. As shown in FIG. 9, the nozzle 10 may be integral with or coupled to the tube 66. For example, if the nozzle 10 is coupled to the tube 66, the nozzle 10 may extend from an insert 68 secured inside the tube 66. In other embodiments, the nozzle 10 may be integral with or coupled to the cap (e.g., cap 56 in FIG. 8). When a cap is coupled to the tube 66 or otherwise closed, the tube 66 is sealed such that the contents of the tube are prevented from leaking under normal conditions.

The tube 66 may include a tube body 70 that is squeezable by a user to extrude the contained oral care composition through the nozzle 10. The tube body 70 may have a shoulder 72. In embodiments where the nozzle 10 is not integral with the tube 66, the tube 66 may include a tube orifice. In embodiments where the nozzle 10 is integral with the tube 66, the nozzle orifice 12 may act as the tube orifice. When the tube is squeezed, the contents of the tube pass through the tube orifice and/or the nozzle orifice 12 to an exterior of the assembly (e.g., onto a toothbrush). The tube body 70 may be sealed by a crimp seal 74 at one end, such as the end of the tube 66 that is opposite from the shoulder 72 or the tube orifice.

The tube 66 may be configured to be releasably coupled with a cap (e.g., cap 56). For example, the tube 66 and cap may include corresponding threads. The cap may include threads (e.g., threads 64 in FIG. 3A) that are configured to be releasably coupled with the threads (not shown) on the tube 66. In an embodiment, the tube 66 may include threads on an exterior surface thereof, and the cap may include threads on an interior surface thereof. In another embodiment, the cap may be configured to snap onto the tube 66.

The tube, the nozzle, and the cap may be made of the same material or be made of different materials. The tube, the nozzle, and the cap may be made of any materials known to those of skill in the art that provide adequate storage of the dentifrice or other product contained in the tube. The materials comprising the assembly should have no reaction with the components that comprise the contents, such that the contents could be rendered unsafe or otherwise unsuitable for consumer use. The materials should, of course, also be durable enough to withstand normal consumer use without leakage, tearing or breakage, etc. The materials may be able to protect the oral care composition from environmental variables (e.g., humidity or light) that may damage the composition over an expected shelf life.

For containing a dentifrice product, non-limiting examples of suitable materials from which the assembly or components thereof may be made of include polyethylenes, such as low density polyethylene (“LDPE”), linear low density polyethylene (“LLDPE”), medial density polyethylene (“MDPE”), and high density polyethylene (“HDPE”), ethylene acrylic acid (“EAA”), foils, such as aluminum foil, or any of the above materials in any combination, for example, formed as a laminate structure. The thickness of the side walls of the tube body may be, for example, from about 0.1 mm to about 0.4 mm, or about 0.3 mm. It is possible to provide thicker or thinner sidewalls, but it is believed that such would not be particularly cost-effective and would not necessarily provide additional dispensing benefits. The material may be a laminate material.

While the description herein is mainly given in the context of a tube having a single interior chamber, it is understood that the body of the present invention may be divided into multiple chambers, each chamber housing a component portion of a composition. Such embodiments are within the scope of the present invention.

### Ion Release

Using a nozzle as described herein to extrude toothpaste may result in improved release of ions from the oral care composition in a slurry. For example, the rate of release of ions from a nurdle during brushing may be increased when using a nozzle according to an embodiment of the present invention compared to a conventional nozzle with an unobstructed circular orifice having the same diameter. While the oral care composition, such as a toothpaste, becomes a slurry during brushing, the ion release profile may be improved compared to a toothpaste dispensed from an unobstructed circular orifice having the same diameter. The ion release or dissolution may be indirectly measured using the concentration of one or more ions when the oral care composition is being mixed to form a slurry. A greater increase in concentration of a target analyte indicates faster release of active agents or aesthetic ingredients from the oral care composition.

The rate of release of dentifrice ingredients into a slurry, when extruded from a nozzle according to an embodiment of the present invention, during the initial 2 minutes of in vitro stirring may be, for example, at least about 2 times, at least about 5 times, or at least about 8 times faster than the ion release rate measured when the same dentifrice from the same tube is extruded through a conventional circular orifice. Within the first 60 seconds of mixing, the percentage of theoretical ion released from a dentifrice nurdle extruded from a nozzle according to an embodiment of the present invention may be at least 2 times, at least 3 times, at least 5 times, or at least 6 times greater than the percentage of theoretical ion released when the same dentifrice from the same tube is extruded through a conventional circular orifice. Within the first 30 seconds of mixing, the AUC of the percentage of theoretical ion released from a dentifrice nurdle extruded from a nozzle according to an embodiment of the present invention may be at least 2 times, at least 3 times, at least 5 times greater than the AUC of the percentage of theoretical ion released when the same dentifrice from the same tube is extruded through a conventional circular orifice.

Another indirect method of measuring ion release is measuring the slurry pH as the oral care composition is being mixed. A faster change in slurry pH indicates faster release of active agents or aesthetic ingredients from the oral care composition. The initial percent change in slurry pH from a dentifrice nurdle extruded from a nozzle according to an embodiment of the present invention may be greater than the percent change in slurry pH when the same dentifrice from the same tube is extruded through a conventional circular orifice. For example, within the first 120 seconds of mixing, the percent change in slurry pH from a dentifrice nurdle extruded from a nozzle according to an embodiment of the present invention may be at least 1.5 times, at least 2 times, at least 2.5 times, at least 5 times greater than the percent change in slurry pH using the same dentifrice from the same tube is extruded through a conventional circular orifice.

Another indirect method of measuring ingredient release is measuring the foam generation during brushing. A difference in the rate or amount of foam generation indicates faster release of ingredients, such as surfactant(s), from the oral care composition. The initial rate of foam generation from a dentifrice nurdle extruded from a nozzle according to an embodiment of the present invention may be greater than the initial rate of foam generation when the same dentifrice from the same tube is extruded through a conventional circular orifice. For example, within the first 10 seconds, 20 seconds, or 30 seconds of brushing, the amount of foam generated from a dentifrice nurdle extruded from a nozzle according to an embodiment of the present invention may be significantly greater than the amount of foam generated using the same dentifrice from the same tube is extruded through a conventional circular orifice.

### Flavor Release

Using a nozzle as described herein to extrude toothpaste may result in improved sensory characteristics. For example, the flavor release or display may be increased when using a nozzle according to an embodiment of the present invention compared to a conventional nozzle with an unobstructed circular orifice having a same diameter. The flavor release may be improved in the nurdle itself (e.g., neat toothpaste) or in a slurry. For example, while the toothpaste becomes a slurry during brushing, the flavor release may be improved compared to a toothpaste dispensed from a conventional circular orifice. The flavor release may be measured as the sum of the total ion chromatogram (TIC) peak areas of flavor components measured in the headspace.

The increase in overall flavor release (neat) from dentifrice, when extruded from a nozzle according to an embodiment of the present invention, after about 15 seconds may be, for example, at least 10%, at least 20%, at least 30%, at least 40%, at least 50%, at least 60%, or at least 70%, or in a range of about 10% to about 90% or about 15% to about 75% higher than the flavor intensity measured when the same dentifrice from the same tube is extruded through a conventional circular orifice. The increase in overall flavor release (neat) at about 30 seconds may be, for example, at least 10%, at least 20%, at least 30%, at least 40%, at least 50%, at least 60%, or at least 70%, or in a range of about 10% to about 90% or about 15% to about 85%. The increase in overall flavor release (neat) at about 60 seconds may be, for example, at least 10%, at least 20%, at least 30%, at least 40%, at least 50%, at least 60%, or at least 70%, or in a range of about 10% to about 90% or about 40% to about 50%.

The increase in overall flavor release (slurry) at about 15 seconds may be, for example, at least 10%, at least 20%, or at least 30%, or in a range of about 5% to about 40%, about 10% to about 35%, about 15% to about 30%, or about 18% to about 27%.

The effect on flavor release may also be measured for individual flavor components. The flavor components may include, without limitation, alpha-pinene, beta-pinene, limonene, eucalyptol, menthone, isomenthone, menthyl acetate, menthol, carvone, anethole, myrcene, p-cymene, and combinations thereof. Some individual components may have a greater increase in flavor release compared to others. For example, the change in flavor release of alpha-pinene up to about 60 seconds may be at least 50%, at least 100%, or at least 200%, or in a range from about 50% to about 400%. The change in flavor release of beta-pinene up to about 60 seconds may be, for example, at least 50%, at least 100%, or at least 250%, or in a range from about 50% to about 350%. In another example, the change in flavor release of limonene up to about 60 seconds may be at least 60%, at least 150%, or at least 300%, or in a range from about 60% to about 425%. For eucalyptol, the change in flavor release up to about 60 seconds may be, for example, at least 30%, at least 75%, or at least 100%, or in a range from about 30% to about 130%. The change in flavor release of menthone up to about 60 seconds may be, for example, at least 25%, at least 50%, or at least 75%, or in a range from about 25% to about 100%. In another example, the change in flavor release of isomenthone up to about 60 seconds may be at least 10%, at least 50%, or at least 70%, or in a range from about 10% to about 85%. For menthyl acetate, the change in flavor release up to about 60 seconds may be, for example, at least 10%, at least 50%, or at least 100%, or in a range from about 10% to about 120%. The change in flavor release of menthol up to about 60 seconds may be, for example, greater than 0%, at least 25%, or at least 60%, or in a range from about −5% to about 75%. In another example, the change in flavor release of carvone up to about 60 seconds may be at least 10%, at least 50%, or at least 70%, or in a range from about 10% to about 80%. For anethole, the change in flavor release up to about 60 seconds may be, for example, at least 20%, at least 50%, or at least 70%, or in a range from about 20% to about 80%. The change in flavor release up to about 30 seconds for individual compounds may be greater than 0%, at least 30%, or at least 50%, or in a range from about −7% to about 65% in a slurry.

### Oral Care Composition

The oral care composition can be in any suitable form, such as a solid, liquid, powder, paste, or combinations thereof. The oral care composition can be dentifrice, tooth gel, subgingival gel, mouth rinse, mousse, foam, mouth spray, lozenge, chewable tablet, chewing gum, tooth whitening strips, floss and floss coatings, breath freshening dissolvable strips, or denture care or adhesive product. The components of the dentifrice composition can be incorporated into a film, a strip, a foam, or a fiber-based dentifrice composition.

The oral care composition can include a variety of active and inactive ingredients, such as, for example, but not limited to a hops extract, a dicarboxylic acid, a calcium ion source, water, a fluoride ion source, a metal source such as a tin ion source and/or a zinc ion source, an antibacterial agent, a bioactive material, a potassium source, a quaternary ammonium compound, a polyphosphate, a humectant, a surfactant, a buffering agent, a monodentate ligand, a polydentate ligand, a thickening agent, an abrasive, an amino acid such as a neutral amino acid or a basic amino acid, a whitening agent, and the like, as well as any combination thereof. The oral care composition can include one or more of the active and inactive ingredients as described in U.S. Pat. No. 11,696,881 or U.S. Patent Publication No. 2021/0346259, each of which is herein incorporated by reference in its entirety.

The nozzle or assembly described herein may be particularly useful for use with an oral care composition having a viscosity range from 150,000 centipoise to 850,000 centipoise (“cP”). A method for assessing viscosity is described. The viscometer is Brookfield® viscometer, Model DV-I Prime with a Brookfield “Helipath” stand. The viscometer is placed on the Helipath stand and leveled via spirit levels. The E spindle is attached, and the viscometer is set to 2.5 RPM. Detach the spindle, zero the viscometer and install the E spindle. Then, lower the spindle until the crosspiece is partially submerged in the paste before starting the measurement. Simultaneously turn on the power switch on the viscometer and the helipath to start rotation of the spindle downward. Set a timer for 48 seconds and turn the timer on at the same time as the motor and helipath. Take a reading after the 48 seconds. The reading is in cP.

### Oral Care Composition Forms

Suitable compositions forms include emulsion compositions, such as the emulsions compositions of U.S. Pat. No. 11,147,753, which is herein incorporated by reference in its entirety, unit-dose compositions, such as the unit-dose compositions of U.S. Patent Application Publication No. 2019/0343732, which is herein incorporated by reference in its entirety, leave-on oral care compositions, jammed emulsions, such as the jammed oil-in-water emulsions of U.S. Pat. No. 11,096,874, which is herein incorporated by reference in its entirety, dentifrice compositions, mouth rinse compositions, mouthwash compositions, tooth gel, subgingival gel, mouth rinse, mousse, foam, mouth spray, lozenge, chewable tablet, chewing gum, tooth whitening strips, floss and floss coatings, breath freshening dissolvable strips, denture care products, denture adhesive products, or combinations thereof.

### Methods

The oral care compositions, as described herein, can lead to oral health benefits, such as the treatment, reduction, and/or prevention of caries, cavities, gingivitis, and/or combinations thereof and/or the whitening of teeth, removing stain from teeth, and/or preventing the accumulation of stain from teeth when applied to the oral cavity. For example, a user can dispense at least a one-inch strip or nurdle of a suitable oral care composition through a nozzle, as described herein, onto an oral care implement, such as a toothbrush, applicator, and/or tray, and applied to the oral cavity and/or teeth. Using a nozzle as described above, dispensing the oral care composition may include on-axis extrusion and off-axis extrusion of the oral care composition.

The user can be instructed to brush teeth thoroughly for at least 30 seconds, at least one minute, at least 90 seconds, or at least two minutes at least once, at least twice, or at least three times per day. The user can also be instructed to expectorate the oral care composition after the completion of the brush procedure. During brushing, the dispensed composition may have a faster ion release during brushing compared to a control dispensed composition made by dispensing the oral care composition through a control nozzle comprising an unobstructed, circular orifice having the orifice diameter.

The user can also be instructed to rinse with a mouthwash and/or mouth rinse composition after the completion of the brush procedure or instead of the brush procedure. The user can be instructed to swish the oral care composition thoroughly for at least 30 seconds, at least one minute, at least 90 seconds, or at least two minutes at least once, at least twice, or at least three times per day. The user can also be instructed to expectorate the oral care composition after the completion of the procedure.

The oral care compositions according to embodiments of the present invention can be used in the treatment, reduction, and/or prevention of caries, cavities, gingivitis, and/or combinations thereof. The oral care compositions according to embodiments of the present invention can be used to provide a whitening benefit, such as the whitening of teeth, removing stain from teeth, and/or preventing the accumulation of stain on teeth.

The oral care composition can include primary packaging, such as a tube, bottle, and/or tub. The primary package can be placed within secondary package, such as a carton, shrink wrap, or the like. Instructions for use of the oral care composition can be printed on the primary package and/or the secondary package. The scope of the method is intended to include instructions provided by a manufacturer, distributor, and/or producer of the oral care composition.

If the oral care composition is a toothpaste, the user can be instructed to dispense the toothpaste from the toothpaste tube.

The user can be instructed to apply a portion of the toothpaste onto a toothbrush. The portion of the toothpaste can be of any suitable shape, such as strip, a pea-sized amount, or various other shapes that would fit onto any mechanical and/or manual brush head. The user can be instructed to apply a strip of the toothpaste that is at least about 1 inch, at least about 0.5 inch, at least 1 inch, and/or at least 0.5 inch long to the bristles of a toothbrush, such as soft-bristled toothbrush.

The user can be instructed to apply pea-sized or grain of rice-sized portion of the toothpaste to the bristles of a toothbrush, such as in the case of use by children of less than 6 years old and/or less than 2 years old.

The user can be instructed to brush their teeth for at least about 30 seconds, at least about 1 minute, at least about 90 seconds, at least about 2 minutes, at least 30 seconds, at least 1 minute, at least 90 seconds, and/or at least 2 minutes.

The user can be instructed to brush their teeth thoroughly and/or as directed by a physician and/or dentist.

The user can be instructed to brush their teeth after each meal. The user can be instructed to brush their teeth at least once per day, at least twice per day, and/or at least three times per day. The user can be instructed to brush their teeth no more than three times a day, such as to prevent Sn staining. The user can be instructed to brush their teeth in the morning and/or in the evening prior to sleeping.

The user can be instructed to not swallow the toothpaste composition due to the inclusion of ingredients that are not suitable for ingestion, such as fluoride. However, in the case of an oral care composition comprising hops, but free of fluoride, the user may not need to be instructed to not swallow the toothpaste. The user may be instructed to expectorate (or spit out) the toothpaste composition after the cessation of the brushing cycle.

The user can be instructed to dispense the mouth rinse from a bottle containing the mouth rinse.

The user can be instructed to use the mouth rinse at least once a day, at least twice a day, and/or at least three times a day.

The user can be instructed to use the mouth rinse composition after the use of toothpaste and/or floss.

The user can be instructed to swish a portion of rinse in the oral cavity, such as between the teeth, for a period of time. The user can be instructed to vigorously swish a portion of the rinse.

The user can be instructed to use be from about 5 mL to about 50 mL, from about 10 mL to about 40 mL, 10 mL, 20 mL, 25 mL, 30 mL, 40 mL, 2 teaspoonfuls, and/or 4 teaspoonfuls of mouth rinse.

The user can be instructed to swish the mouth rinse for at least about 30 seconds, at least about 1 minute, at least about 90 seconds, at least about 2 minutes, at least 30 seconds, at least 1 minute, at least 90 seconds, and/or at least 2 minutes.

The user can be instructed to not swallow the mouth rinse composition due to the inclusion of ingredients that are not suitable for ingestion, such as fluoride. However, in the case of an oral care composition comprising hops, but free of fluoride, the user may not need to be instructed to not swallow the mouth rinse. The user may be instructed to expectorate (or spit out) the mouth rinse composition after the cessation of the rinse cycle.

The usage instructions for the oral care composition, such as for a toothpaste composition and/or a mouth rinse composition, can vary based on age. For example, adults and children that are at least 6 or at least 2 can have one usage instruction while children under 6 or under 2 can have a second usage instruction.

Additionally, the oral care composition, as described herein, can be used to reduce the number and/or intensity of white spots on teeth, which can be attributable to caries presence within the oral cavity. Or the oral care composition, as described herein, can be used to reduce the redness, puffiness, tenderness, and/or swollenness of gums at the gumline immediately adjacent the surfaces of the teeth, which can be attributable to gingivitis presence within the oral cavity.

### Combinations

A. A method for using an oral care composition comprising:
   dispensing the oral care composition through a nozzle to form a dispensed composition, wherein the nozzle comprises:
      an orifice having a central axis and an orifice diameter; and
      fins partially occluding the orifice; and
   brushing teeth with the dispensed composition to form a slurry,
   wherein the dispensed composition has a faster ion release during brushing compared to a control dispensed composition made by dispensing the oral care composition through a control nozzle comprising an unobstructed, circular orifice having the orifice diameter.
B. The method as disclosed in A, wherein a center of the orifice is occluded.
C. The method as disclosed in A or claim B, wherein the nozzle further comprises a central hub, wherein the fins are coupled to the central hub.
D. The method as disclosed in A, wherein the fins are not in contact with a central hub.
E. The method as disclosed in any one of A-D, wherein each of the fins has an upper surface and a lower surface, and the upper surface of each of the fins is distal of the orifice.
F. The method as disclosed in any one of A-E, wherein the lower surface of each of the fins is proximal of the orifice.
G. The method of any as disclosed in any one of A-F, wherein the lower surface of each of the fins is distal of the orifice.
H. The method as disclosed in any one of A-G, wherein the nozzle further comprises an on-axis extrusion area and an off-axis extrusion area.
I. The method as disclosed in any one of A-H, wherein the nozzle further comprises a sidewall defining the orifice, wherein the sidewall comprises an inner wall, a rim, and an outer wall.
J. The method as disclosed in I, wherein each of the fins further comprise an outer end that extends to the outer wall of the sidewall.
K. The method as disclosed in I, wherein the lower surface of each of the fins extends from the inner surface of the sidewall.
L. The method as disclosed in any one of A-K, wherein the oral care composition comprises fluoride and, after 15 seconds of brushing, a fluoride concentration in the slurry is greater than a control fluoride concentration in a control slurry after 15 seconds of brushing the control dispensed composition.
M. The method as disclosed in L, wherein the fluoride concentration is more than three times greater than the control fluoride concentration.
N. The method as disclosed in any one of A-L, wherein the oral care composition comprises fluoride and, after 30 seconds of brushing, a fluoride concentration in the slurry is greater than a control fluoride concentration in a control slurry after 30 seconds of brushing the control dispensed composition.
O. The method as disclosed in N, wherein the fluoride concentration is more than two times greater than the control fluoride concentration.
P. A method for using an oral care composition comprising:
   dispensing the oral care composition through a nozzle to form a dispensed composition, wherein the nozzle comprises:
      an orifice having a central axis and an orifice diameter; and
      fins partially occluding the orifice;
   adding the dispensed composition to a liquid; and
   forming a slurry of the dispensed composition and the liquid,
   wherein the dispensed composition has a faster ion release in the slurry compared to a control dispensed composition made by dispensing the oral care composition through a control nozzle comprising an unobstructed, circular orifice having the orifice diameter.
Q. Use of a nozzle having a partially occluded orifice for increasing an initial ion release rate of an oral care composition.

### Examples

The invention is further illustrated by the following examples, which are not to be construed in any way as imposing limitations to the scope of this invention. Various other aspects, modifications, and equivalents thereof which, after reading the description herein, may suggest themselves to one of ordinary skill in the art without departing from the spirit of the present invention or the scope of the appended claims.

### Method of Measuring Ion Release

### Sample Preparation

Samples for evaluating changes to ion release or dissolution from a given dentifrice were prepared by squeezing a dentifrice sample from the same tube of dentifrice through a given nozzle into an 80 mL titration cup. The samples weighed 2.0 g (+/−0.5 g), as measured using a Mettler Toledo® XPE 504 balance (Mettler Toledo, Columbus, OH, USA).

### Titrator Analysis Method

The cup was placed on a Mettler Toledo® SD 660 Autosampler (Mettler Toledo, Columbus, OH, USA) attached to a Mettler Toledo® T7 Titrator (Mettler Toledo, Columbus, OH, USA) where a Mettler Toledo® propeller mixer (Mettler Toledo, Columbus, OH, USA) and either the fluoride ion selective electrode (ISE) (Thermo Scientific, Chelmsford, MA, USA; Part number 9609BNEP) or the pH probe (Cole-Parmer pH Probe, Vernon Hills, IL, USA; Part number 05990-65) are inserted. The titrator added 20 mL of Milli-Q® water from Millipore® Milli-Q IQ 7000 system (MilliporeSigma, Rockville, MD, USA; part number ZIQ7000TOC) and 20 mL of 1% TISAB II buffer (Thermo Fisher Scientific, Rockwood, TN, USA; part number 940909) by mechanical means to the cup. The propeller stirred at a rate of 31% (pH) or 32% (fluoride) per the Lab-X software (Mettler Toledo, Columbus, OH, USA). For fluoride measurement, the ISE measured the amount of fluoride ion that was released into the water: TISAB II mixture as the propeller stirred, dispersing the paste into solution over the course of several minutes. For pH measurement, the pH probe measured the millivolt change of the solution as the propeller stirred dispersing the paste into a slurry solution for 6 minutes. This process was repeated 6 times for each nozzle.

### Data Processing

The absolute fluoride ion (F⁻) concentration in solution was converted into a percent of the total theoretical fluoride ion content based on recorded sample weight and a formulated concentration of 1100 ug/g fluoride ion in the finished product paste. This approach normalizes the data, allowing direct comparison between samples.

The slurry pH data were directly compared; there was no mathematical normalization.

Use of Analyte Release to Represent Release of Ingredients from the Composition

The method above and results below are based on the measurement of the release of fluoride ions or slurry pH changes. Of note, other analytes or ions present in the formula may be chosen to demonstrate the rate of release of the individual ingredients from the nurdle. For example, the target analyte could be potassium or sodium. As another example, a non-specific measure of total conductivity could be used as the endpoint. Any of the above measurement techniques are appropriate to measure the release rate from dentifrice in water.

### Nozzles

The effect of the nozzle design on ion release or dissolution was assessed using a Comparative Nozzle 1 and Inventive Nozzles 1-3. Comparative Nozzle 1 has a circular, unobstructed orifice with a diameter of about 9.0 mm. Inventive Nozzles 1-3 are described in Table 1. The fins of Inventive Nozzles 1-3 were not inclined (i.e., 0° angle).

TABLE 1
Nozzle Design

| | Compar- | Inven- | Inven- | Inven- |
|---|---|---|---|---|
| | ative | tive | tive | tive |
| | Nozzle 1 | Nozzle 1 | Nozzle 2 | Nozzle 3 |
| Number of fins | 0 | 5 | 4 | 6 |
| Fin width (mm) | n/a | 2.56 | 3.13 | 1.82 |
| Fin length (mm) | n/a | 4.28 | 4.02 | 3.68 |
| Fin thickness (mm) | n/a | 1.0 | 1.0 | 1.0 |
| Fin elevation (mm) | n/a | −0.50 | −0.50 | −0.50 |
| Disk diameter (mm) | n/a | 3.0 | 3.0 | 3.0 |
| Orifice diameter (mm) | 9.0 | 9.0 | 8.0 | 8.0 |
| Restricted area (mm²) | 0.0 | 33.1 | 42.6 | 38.1 |
| On-axis extrusion area | 63.6 | 30.5 | 21.0 | 25.5 |
| (mm²) | | | | |

### Fluoride Release Results and Discussion

The fluoride concentration was measured over time as Crest® Pro-Health Clean Mint (“Pro-Health”) was mixed to form a slurry. The fluoride slurry concentration data for each sample is shown below in Table 2.

TABLE 2
Percent of Theoretical F⁻ Ion Release over Time

| Time (s) | 60 | 120 | 180 | 240 | 300 | 360 |
|---|---|---|---|---|---|---|
| Comparative Nozzle 1 (9.0 mm) | 7.77 | 10.7 | 14.5 | 26.2 | 30.0 | 32.9 |
| Inventive Nozzle 1 (9.0 mm) | 49.6 | 65.3 | 69.7 | 79.8 | 82.0 | 83.3 |
| Std error (n = 6) Comparative Nozzle 1 | 0.8 | 1.1 | 1.6 | 9.7 | 10.3 | 10.2 |
| Std error (n = 6) Inventive Nozzle 1 | 9.9 | 9.8 | 9.4 | 1.5 | 0.8 | 0.7 |

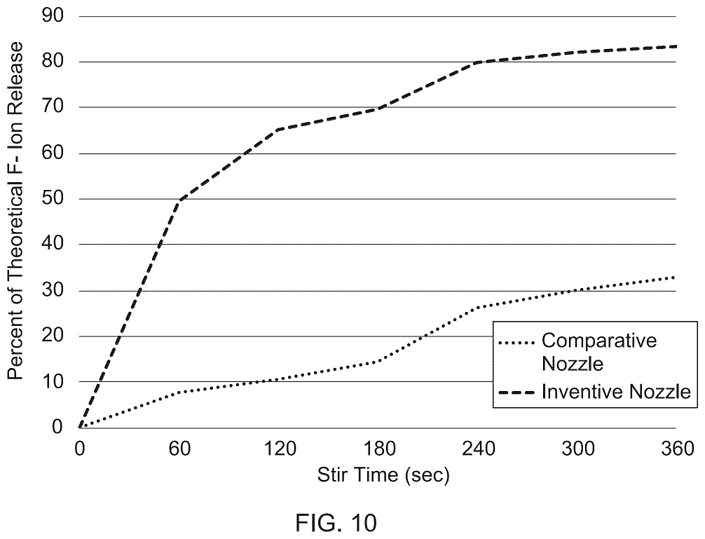

Unexpectedly, the results in Table 2, which are also shown in FIG. 10, show that the fluoride concentration in the slurry was higher at all stir times for Inventive Nozzle 1 versus Comparative Nozzle 1. The percentage of ion release from the same dentifrice but different nozzles is expected to reach the same endpoint given sufficient mixing time. Because the data was normalized as discussed above, and because the same dentifrice was used, it is believed this faster release of fluoride was due to the partially obstructed design of Inventive Nozzle 1. The faster release of fluoride indicates that the dentifrice extruded through Inventive Nozzle 1 had a faster initial dissolution rate than the dentifrice extruded through Comparative Nozzle 1. The dentifrice was blue in color, and the significant difference in rate of release was visually noticed as well. The slurry for the Inventive Nozzle 1 became opaque blue almost immediately after the stirring began, while the dentifrice nurdle from Comparative Nozzle 1 remained intact in a clear solution during the initial stirring time. This effect of a partially obstructed nozzle orifice on the rate of ion release rate was unknown. As previously mentioned, many users brush their teeth for less than the recommend amount of time. Faster ion release from the dentifrice and thus faster release of the active agent(s) may increase the amount of time during any given brushing session that the active agent(s) are able to provide their respective benefits before the dentifrice is expectorated. Given that the action of dentifrice is topical and the oral cavity is largely a clearance organ (meaning saliva flow and swallowing are constantly flushing oral tissues), the kinetics of ingredient release are of high importance.

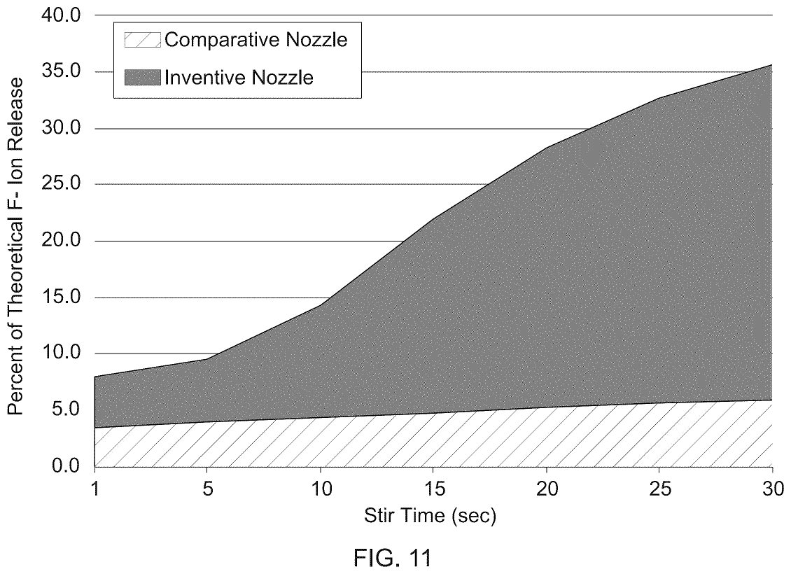

As a means of comparison, the area under the curve (AUC) was calculated for both Comparative Nozzle 1 and Inventive Nozzle 1. Quantifying the data in this way helps distinguish the relative ion release performance of each type of dispensing (through either nozzle). The AUC is a mathematical representation of the amount of actives that could be available to the oral cavity at a given slurry time. The results are shown in Table 3 and FIG. 11.

TABLE 3
AUC of Percent of Theoretical F⁻ Ion Release over Time

| Time (s) | 1 | 5 | 10 | 15 | 20 | 25 | 30 |
|---|---|---|---|---|---|---|---|
| Comparative Nozzle 1 (9.0 mm) | 3.5 | 4.0 | 4.3 | 4.7 | 5.2 | 5.6 | 5.9 |
| Inventive Nozzle 1 (9.0 mm) | 4.5 | 5.5 | 9.9 | 17.3 | 23.0 | 27.1 | 29.8 |
| Std error (n = 6) Comparative Nozzle 1 | 0.071 | 0.054 | 0.11 | 0.19 | 0.43 | 0.56 | 0.60 |
| Std error (n = 6) Inventive Nozzle 1 | 0.28 | 0.45 | 2.6 | 5.1 | 7.1 | 8.7 | 9.6 |

FIG. 11 shows the first 30 seconds of mixing. FIG. 11 shows that significantly more fluoride was released from the dentifrice extruded through Inventive Nozzle 1 in the first several seconds of stirring as compared to the same dentifrice extruded through Comparative Nozzle 1, with all other variables being held constant. These results indicate that a user would experience the benefits of the toothpaste much faster using a nozzle according to an embodiment of the present invention compared to a conventional, unobstructed nozzle.

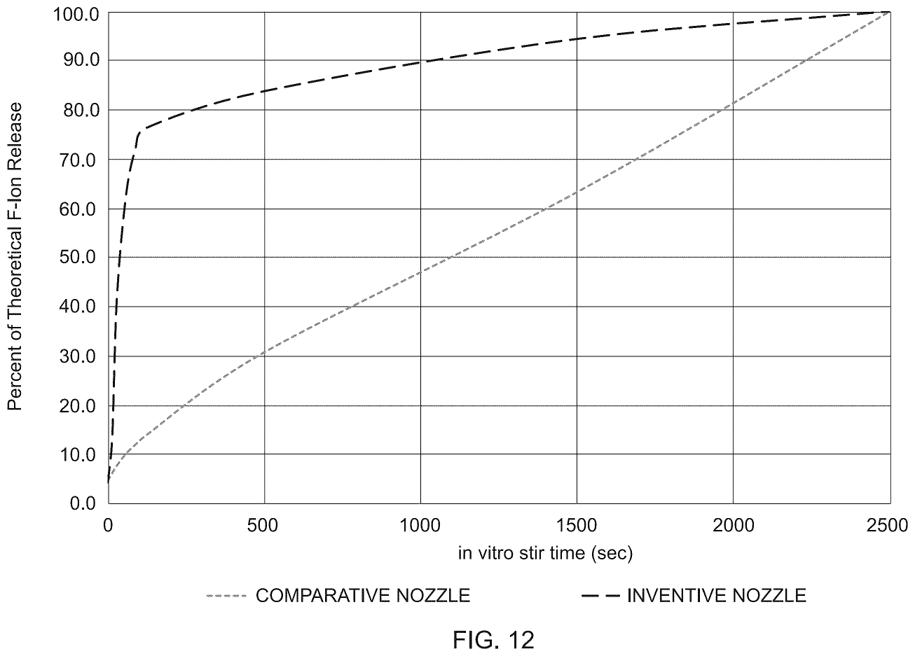

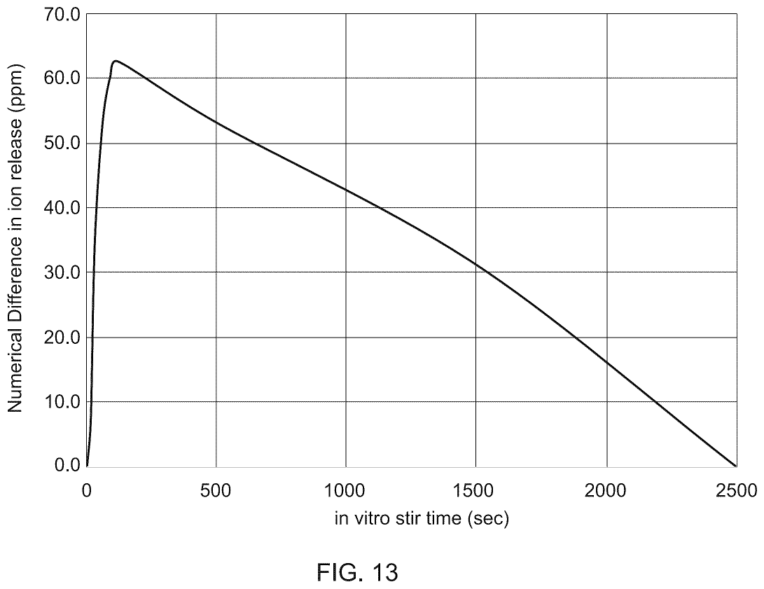

To further evaluate the effect of nozzle design over time, nurdles extruded through Comparative Nozzle 1 and Inventive Nozzle 1 were stirred until 100% of theoretical fluoride ion was released. The results are shown in Table 4 and FIG. 12. The numerical difference between the ion release (%) for Comparative Nozzle 1 and Inventive Nozzle 1 is also shown in Table 4 and FIG. 13.

TABLE 4
Percent of Maximum Fluoride Ion Release into Slurry

| | Percent Ion Release | | Numerical |
|---|---|---|---|
| | COMPARATIVE | INVENTIVE | Difference |
| t (s) | NOZZLE 1 | NOZZLE 1 | (%) |
| 1 | 4.6 | 4.4 | 0.2 |
| 15 | 6.2 | 13.6 | 7.4 |
| 30 | 7.8 | 42.0 | 34.3 |
| 60 | 10.2 | 63.1 | 52.9 |
| 90 | 12.1 | 72.3 | 60.2 |
| 120 | 13.7 | 76.2 | 62.5 |
| 500 | 30.7 | 83.8 | 53.1 |
| 1500 | 63.3 | 94.4 | 31.1 |
| 2500 | 100 | 100 | 0.0 |

Employment of the Inventive Nozzle 1 resulted in rapid ion release from the paste within the first several seconds of in vitro stirring, this release rate peaks after about 2 minutes of slow stirring in vitro, then levels out to a steady state until 100% ion release is achieved. Comparative Nozzle 1 results in a steady ion release rate over the entire stir time.

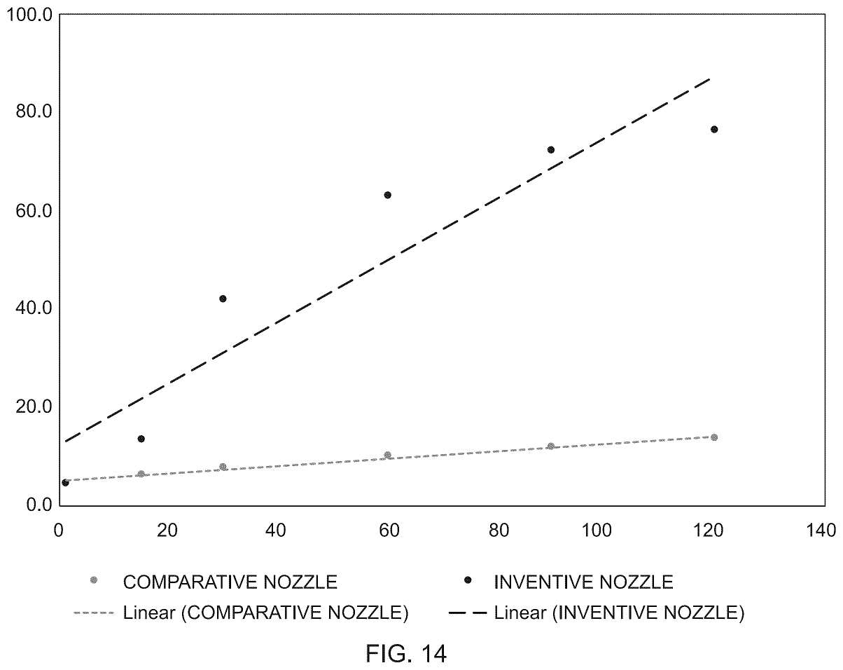

Inventive Nozzle 1 results in rapid release of ions upon initial stirring, whereas Comparative Nozzle 1 results in a relatively steady release of ions over time. FIG. 14 shows the rate of change of the percentage of theoretical ion release in the first two minutes of slurrying. The rate of ion release for Inventive Nozzle 1 is about 0.62 ppm/sec vs. about 0.08 ppm/sec for Comparative Nozzle 1 at two minutes after the start of mixing. Although both designs produce nurdles that eventually achieve 100% ion release, Inventive Nozzle 1 increases ion release rate within the first two minutes by about 8 times.

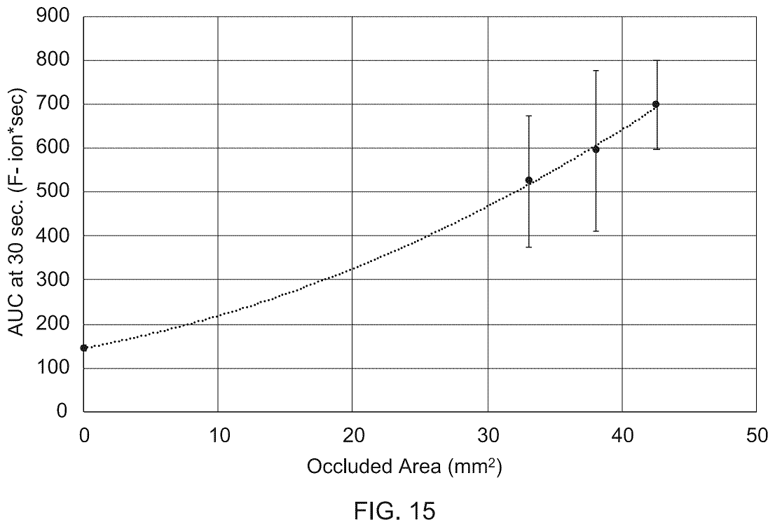

Given these surprising results, the effect of additional partially obstructed nozzle designs (Inventive Nozzles 2 and 3) on ion release was assessed. Table 5 shows the results comparing the AUC of fluoride concentration over time taken at 30 seconds of mixing for Comparative Nozzle 1 and Inventive Nozzles 1-3. The results are also shown in FIG. 15.

TABLE 5
AUC of Percent of Theoretical F⁻
Ion Release over Time at 30 seconds

| | Compar- | Inven- | Inven- | Inven- |
|---|---|---|---|---|
| | ative | tive | tive | tive |
| | Nozzle 1 | Nozzle 1 | Nozzle 2 | Nozzle 3 |
| # Of fins | 0 | 5 | 4 | 6 |
| Orifice diameter (mm) | 9.0 | 9.0 | 8.0 | 8.0 |
| Restricted area (mm²) | 0.0 | 33.1 | 42.6 | 38.1 |
| On-axis extrusion area | 63.6 | 30.5 | 21.0 | 25.5 |
| (mm²) | | | | |
| AUC at 30 sec stir time | 144.9 | 524.7 | 699.1 | 594.2 |
| (avg n = 6) | | | | |
| Std dev (n = 6) | 7.8 | 148.7 | 101.9 | 182.6 |

These results suggest a previously unknown positive correlation between orifice occlusion and enhanced ion release from a dentifrice nurdle.

### Shear Control Comparison

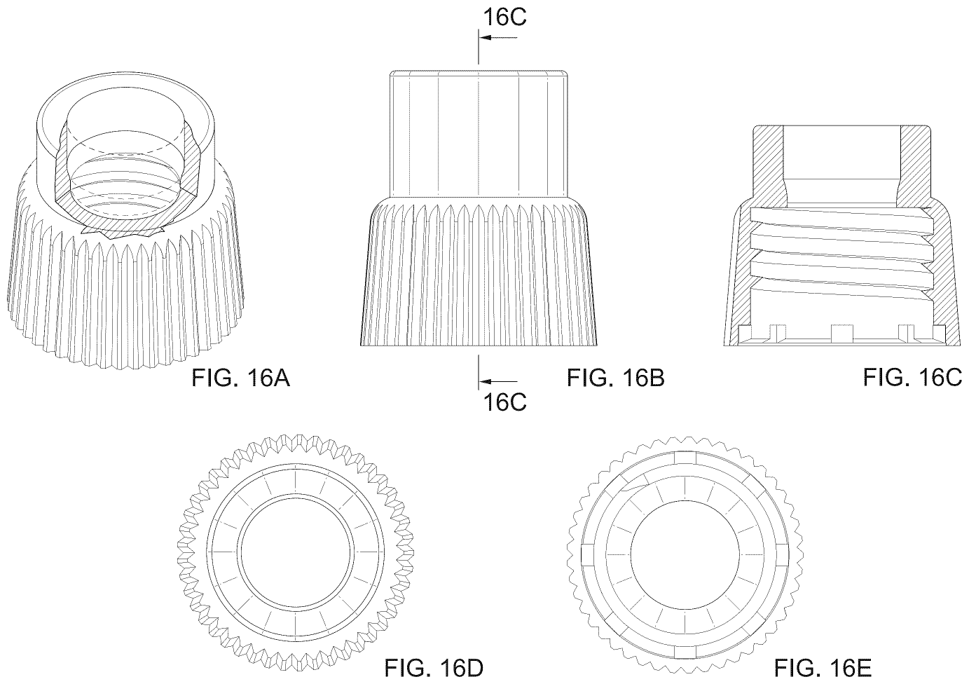

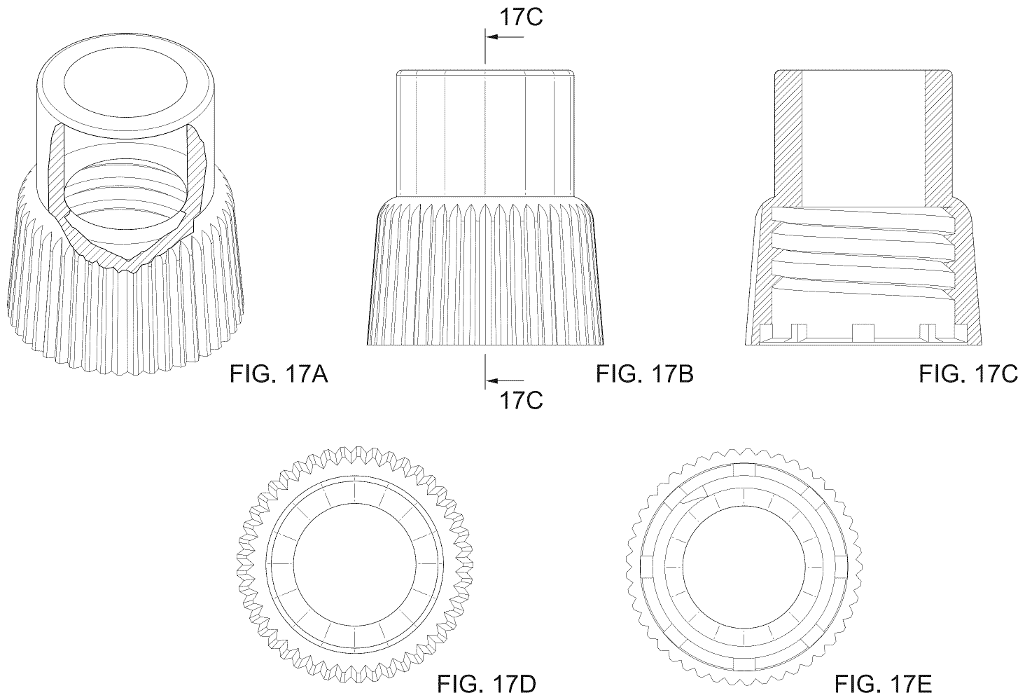

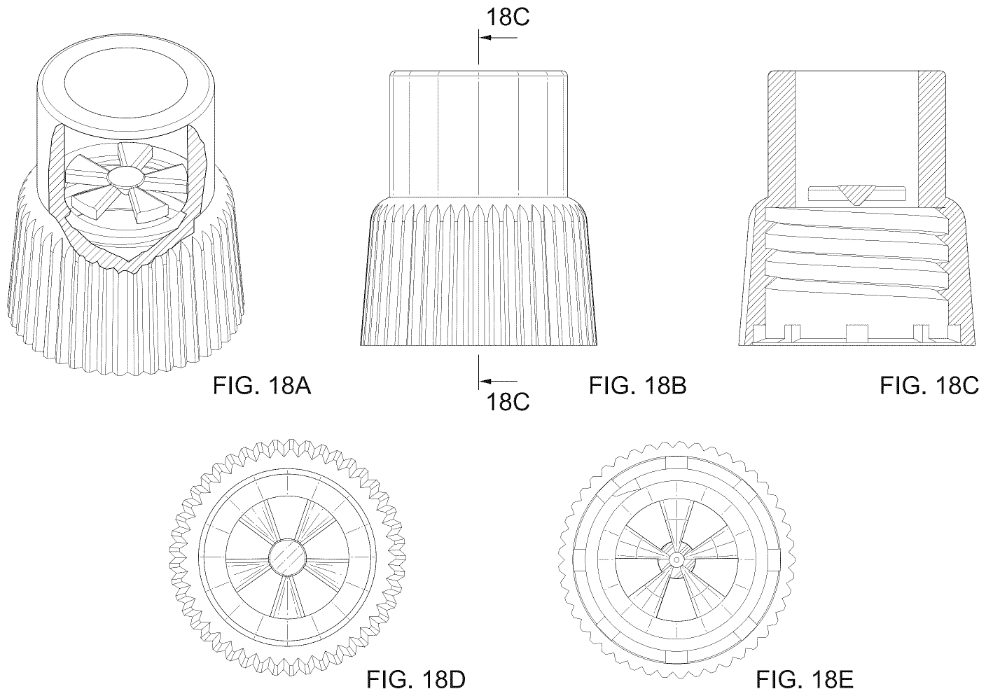

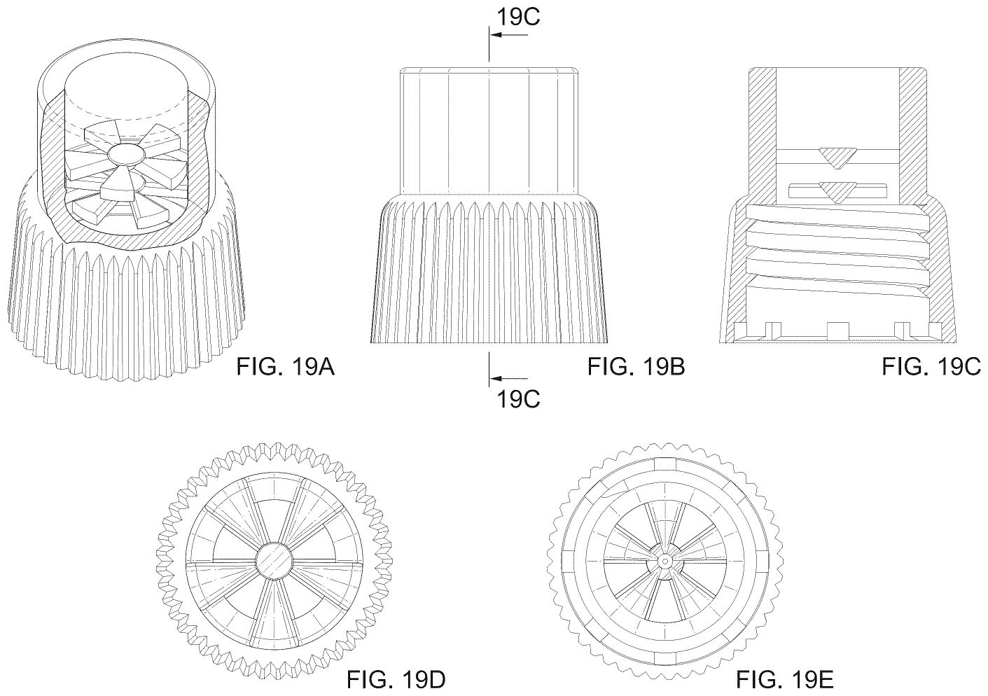

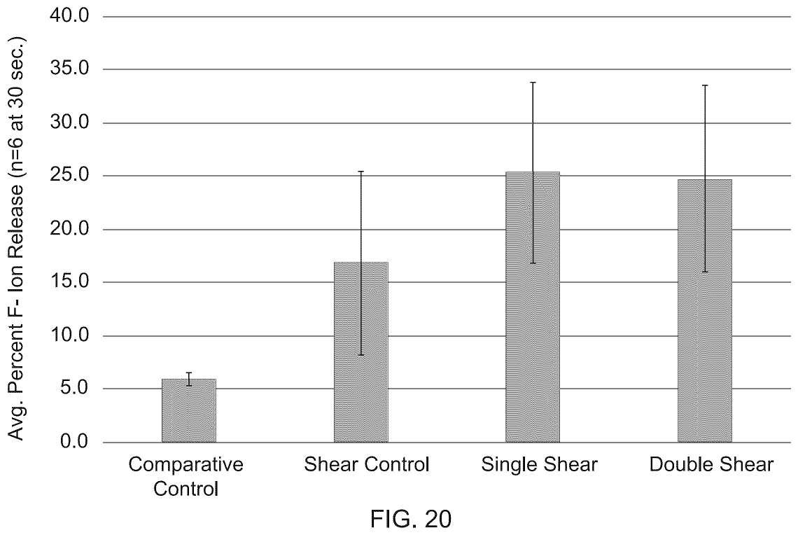

To better understand the mechanism behind the surprising correlation between orifice occlusion and ion release, additional study of the impact of shear force on dentifrice ion release was assessed. In addition to Comparative Nozzle 1, three prototype nozzles were generated to study impact of shear on ion release. Comparative Nozzle 1 (FIGS. 16A-16E) has an inner wall length of 7.0 mm compared to 11.0 mm in Comparative Nozzle 2 (FIGS. 17A-17E). Inventive Nozzle 4, as shown in FIGS. 18A-18E, has one set of fins and a corresponding central hub within the interior of the nozzle. Inventive Nozzle 5, as shown in FIGS. 19A-19E, has two sets of fins and corresponding central hubs within the interior of the nozzle. Table 6 and FIG. 20 show the results comparing the area under the curve (AUC) of fluoride ion release after 30 seconds of mixing for the Comparative Nozzles 1 and 2 and Inventive Nozzles 4 and 5.

TABLE 6
Percent of Theoretical F⁻ Ion Release for Various Nozzles

| | Compar- | Compar- | Inven- | Inven- |
|---|---|---|---|---|
| | ative | ative | tive | tive |
| | Nozzle 1 | Nozzle 2 | Nozzle 4 | Nozzle 5 |
| Inner Orifice Diameter | 9.0 | 9.0 | 9.0 | 9.0 |
| (mm) | | | | |
| Inner Wall Length (mm) | 7.0 | 11.0 | 11.0 | 11.0 |
| Number of Occlusive | 0 | 0 | 1 | 2 |
| Layers | | | | |
| Percent Theoretical F⁻ | 5.9 | 16.9 | 25.4 | 24.7 |
| Release at 30 sec stir | | | | |
| time (avg n = 6) | | | | |
| Std dev (n = 6) | 0.6 | 8.6 | 8.5 | 8.7 |

These results suggest that mechanical shear may not have a strictly linear relationship with enhanced ion release from a dentifrice nurdle, but that there may be a threshold amount of shear that could produce a significantly improved release rate. Because the partially occluded orifice of the Inventive Nozzles imparts changes to both shear forces and surface area, it is likely that both factors could have a role in enhanced ion release. For instance, in comparing the results of Comparative Nozzles 1 and 2, it was discovered that simply elongating the nozzle has a positive correlation with increased rate of ion dissolution. This is likely due to shear wall effects and laminar flow of the paste composition along the nozzle wall during dispensing. Additionally, any design parameter that results in a change to size of orifice occlusion or change to flow path of paste could likewise change the shear rate of the system, which could also have an impact on the rate of dissolution. Of note, toothpaste is both a yield stress fluid and a shear thinning fluid, which begins to flow only upon application of shear stress/force and thins upon increase in shear force and/or shear rate. Additionally, any decrease of viscosity that may occur as a result of applied force may additionally play a role in enhanced ion release upon slurrying.

### Dentifrice Chassis Comparison

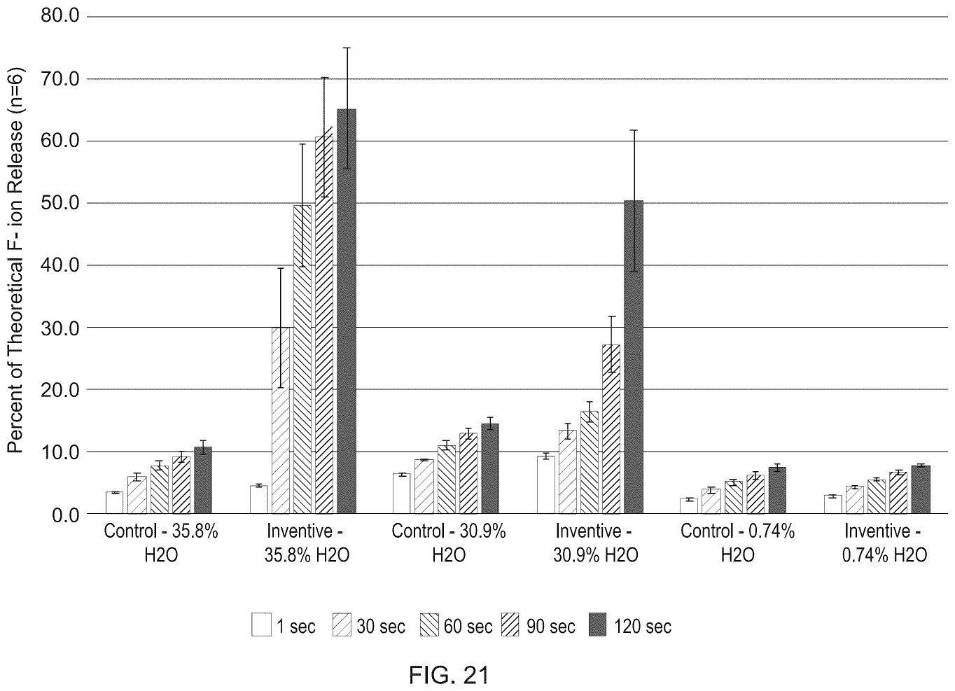

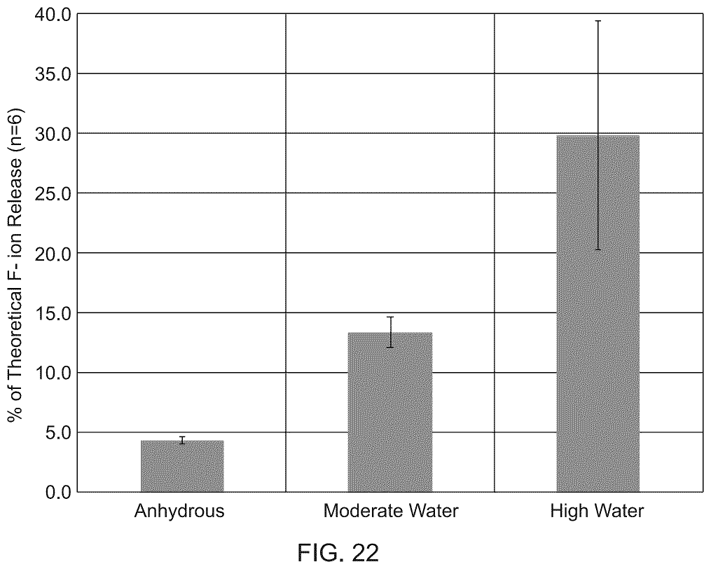

The effect on ion release from a partially occluded orifice was evaluated for a variety of dentifrice chasses with differing starting levels of hydration. Three different dentifrice formulas with varying water content and binder systems were tested. The three dentifrices were used: Crest ProHealth (Dentifrice A), Crest Cavity Protection (Dentifrice B), and Crest ProHealth Advanced (Dentifrice C). Dentifrice A has a high water content of 35.8%, Dentifrice B has a moderate water content of 30.9%, and Dentifrice C is anhydrous with less than 1.0% water. Table 7 shows the results comparing the three dentifrices. FIG. 21 shows a comparison of the percent of theoretical fluoride ion release from the Dentifrices A-C for Comparative Nozzle 1 and Inventive Nozzle 1. FIG. 22 shows the percent of theoretical fluoride ion release from Dentifrices A-C after 30 seconds for Inventive Nozzle 1.

TABLE 7
Percent of Theoretical F⁻ Ion Release for Various Dentifrices

| | | | | |
|---|---|---|---|---|
| | Comparative | | Inventive | |
| Time (s) | Nozzle 1 | std error | Nozzle 1 | std error |

Dentifrice A (35.8% water)

| | | | | |
|---|---|---|---|---|
| 1 | 3.46 | 0.07 | 4.53 | 0.3 |
| 30 | 5.86 | 0.60 | 29.84 | 9.6 |
| 60 | 7.77 | 0.78 | 49.63 | 9.9 |
| 90 | 9.16 | 0.96 | 60.71 | 9.6 |
| 120 | 10.66 | 1.10 | 65.26 | 9.8 |

Dentifrice B (30.9% water)

| | | | | |
|---|---|---|---|---|
| 1 | 6.31 | 0.29 | 9.19 | 0.53 |
| 30 | 8.66 | 0.22 | 13.36 | 1.24 |
| 60 | 11.01 | 0.70 | 16.36 | 1.68 |
| 90 | 12.81 | 0.87 | 27.21 | 4.52 |
| 120 | 14.50 | 1.01 | 50.41 | 11.48 |

Dentifrice C (0.74% water)

| | | | | |
|---|---|---|---|---|
| 1 | 2.29 | 0.36 | 2.86 | 0.27 |
| 30 | 3.85 | 0.46 | 4.31 | 0.28 |
| 60 | 5.09 | 0.54 | 5.51 | 0.29 |
| 90 | 6.27 | 0.62 | 6.65 | 0.29 |
| 120 | 7.46 | 0.69 | 7.77 | 0.31 |

Interestingly, the results showed that for high and moderate water content chasses, the shaped orifice provides a distinct enhancement in rate of ion release. Dispensing Dentifrice C, an anhydrous product, through a shaped orifice (application of shear force and increased surface area) did not appear to impact the rate of ion release into the slurry. The anhydrous Dentifrice continues to show slow, linear ion release rate for both nozzle types when slurried under these modest mixing conditions.

### pH Results and Discussion

The pH was evaluated over time as Crest® Pro-Health Clean Mint (“Pro-Health”) was mixed to form a slurry. The pH was determined based on the mV reading of the slurry. The mV data for each sample (n=6) is shown below in TABLE 8.

TABLE 8
Average mV Reading Raw Data

| | Comparative | | Inventive | |
|---|---|---|---|---|
| t [s] | Nozzle 1 | Std Error | Nozzle 1 | Std Error |
| baseline | 78.1 | 0.3 | 78.2 | 0.3 |
| 0 | 78.3 | 0.4 | 78.4 | 0.4 |
| 120 | 72.0 | 4.7 | 62.3 | 5.7 |
| 240 | 70.2 | 4.4 | 56.6 | 3.8 |
| 360 | 68.5 | 4.0 | 53.2 | 3.3 |

Because the pH probe reading took up to several seconds to stabilize in each new solution, the probe was allowed to equilibrate before t=0 was set. The baseline measurement was the probe mV reading when initially placed in sample solution. Once the probe equilibrated and the reading stabilized, the timer was started for t=0.

The percent change over time in the mV reading compared to the baseline reading is shown in TABLE 9. The average pH over time as calculated from the mV data is shown in TABLE 10.

TABLE 9
Percent Change in mV from Baseline

| t [s] | Comparative Nozzle 1 | Inventive Nozzle 1 |
|---|---|---|
| 0 | 0.3 | 0.3 |
| 120 | 7.9 | 21.0 |
| 240 | 10.2 | 27.9 |
| 360 | 12.2 | 32.0 |

TABLE 10
Average pH over Time

| t [s] | Comparative Nozzle 1 | Inventive Nozzle 1 |
|---|---|---|
| 0 | 5.6 | 5.6 |
| 120 | 5.7 | 5.9 |
| 240 | 5.8 | 6.0 |
| 360 | 5.8 | 6.1 |

Unexpectedly, the results in Tables 8-10, which are also shown in FIGS. 23-25, respectively, show that the pH in the slurry had a greater increase from baseline at all stir times for Inventive Nozzle 1 versus Comparative Nozzle 1. The effect on pH from the same dentifrice but different nozzles is expected to reach the same endpoint given sufficient mixing time. Because the same dentifrice was used, it is believed this faster change in pH was due to the partially obstructed design of Inventive Nozzle 1. The faster change in pH indicates that the dentifrice extruded through Inventive Nozzle 1 has a faster initial dissolution rate than the dentifrice extruded through Comparative Nozzle 1. This effect of a partially obstructed nozzle orifice on the rate of pH change was unknown. As previously mentioned, many users brush their teeth for less than the recommend amount of time. As discussed above, faster release of the active agent(s) may increase the amount of time during any given brushing session that the active agent(s) are able to provide their respective benefits before the dentifrice is expectorated.

### Method of Measuring Foam Generation

The effects of Comparative Nozzle 1 and Inventive Nozzle 1 on foam generation were compared.

### Sample Preparation

Samples for evaluating the effect of nozzle shape on foam generation were prepared by squeezing a 1.0 g (+/−0.1 g) dentifrice sample from the same tube of dentifrice through a given nozzle onto a toothbrush (Anchor, 41 Tuft White Toothbrushes, Team Technologies, Inc, Morristown, TN, USA; part number 07771HC).

### Foam Analysis Method

A Descriptive Profile Panel (“DPP”) conducted a sensory test to understand the amount of foam generated from three dentifrice formulations differing in foam amount dispensed by each nozzle shape. The three formulations included Crest® Pro-Health Gum Detoxify, Crest® Pro-Health Advanced Deep Clean Mint, and Crest® 3D White Brilliance Vibrant Peppermint. The DPP panels included between 12-14 panelists that were trained and validated in a modified Spectrum™ Descriptive Analysis methodology. Panelists assessed the foam amount at 6-time intervals separated by 10 seconds while brushing. The evaluation was conducted on a scale ranging from 0 (no foam) to 60 (extreme foam amounts) for each time point, following a standardized 60-second brushing protocol. The results were analyzed in JMP® Pro 17.1.0 (JMP Statistical Discovery LLC, Cary, NC). Data were averaged for descriptive panel results across panelists, and the order was defined as a random variable. The full model included paste and nozzle as main effects. Least squares means were calculated with Fisher's least significant difference (p<0.05).

### Foam Results and Discussion

The foam amount was assessed over time from three different toothpastes dispensed from two different nozzles. The results of the expert panel analysis of foam generation for each nozzle are shown below in TABLE 11.

TABLE 11
Effect of Nozzle on Foam Over Time

| t [s] | Comparative Nozzle 1 | Inventive Nozzle 1 | p-Value |
|---|---|---|---|
| 10 | 6.0 | 6.9 | 0.18 |
| 20 | 13.3^{b} | 15.6^{a} | 0.04 |
| 30 | 21.1 | 22.8 | 0.14 |
| 40 | 27.3 | 28.6 | 0.25 |
| 50 | 33.2 | 34.6 | 0.22 |
| 60 | 39.6 | 41.3 | 0.20 |

^{ab}Mean values within a row followed by the same letter are not significantly different (p < 0.05)

The results in TABLE 11 demonstrate that Inventive Nozzle 1 generated more foam than Comparative Nozzle 1 nozzle over time. At each time point evaluated, Inventive Nozzle 1 consistently trended higher in foam amount than the Comparative Nozzle 1. The effect on foam generation from the same dentifrice but different nozzles is expected to reach the same endpoint given sufficient time. Notably, a statistically significant difference (p<0.05) was observed at the 20-second time point, with Inventive Nozzle 1 generating significantly more foam than Comparative Nozzle 1. This indicates that Inventive Nozzle 1 had a more pronounced effect on foam production during the early stages of brushing when foam is beginning to develop. This effect of a partially obstructed nozzle orifice on the rate of foam generation was unknown.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests, or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method for using an oral care composition comprising:
dispensing the oral care composition through a nozzle to form a dispensed composition, wherein the nozzle comprises:
an orifice having a central axis and an orifice diameter; and
fins partially occluding the orifice; and
brushing teeth with the dispensed composition to form a slurry,
wherein the dispensed composition has a faster ion release during brushing compared to a control dispensed composition made by dispensing the oral care composition through a control nozzle comprising an unobstructed, circular orifice having the orifice diameter.

2. The method of claim 1, wherein a center of the orifice is occluded.

3. The method of claim 1, wherein the nozzle further comprises a central hub, wherein the fins are coupled to the central hub.

4. The method of claim 1, wherein the fins are not in contact with a central hub.

5. The method of claim 1, wherein each of the fins has an upper surface and a lower surface, and the upper surface of each of the fins is distal of the orifice.

6. The method of claim 1, wherein the lower surface of each of the fins is proximal of the orifice.

7. The method of claim 1, wherein the lower surface of each of the fins is distal of the orifice.

8. The method of claim 1, wherein the nozzle further comprises an on-axis extrusion area and an off-axis extrusion area.

9. The method of claim 1, wherein the nozzle further comprises a sidewall defining the orifice, wherein the sidewall comprises an inner wall, a rim, and an outer wall.

10. The method of claim 9, wherein each of the fins further comprise an outer end that extends to the outer wall of the sidewall.

11. The method of claim 9, wherein the lower surface of each of the fins extends from the inner surface of the sidewall.

12. The method of claim 1, wherein the oral care composition comprises fluoride and, after 15 seconds of brushing, a fluoride concentration in the slurry is greater than a control fluoride concentration in a control slurry after 15 seconds of brushing the control dispensed composition.

13. The method of claim 12, wherein the fluoride concentration is more than three times greater than the control fluoride concentration.

14. The method of claim 1, wherein the oral care composition comprises fluoride and, after 30 seconds of brushing, a fluoride concentration in the slurry is greater than a control fluoride concentration in a control slurry after 30 seconds of brushing the control dispensed composition.

15. The method of claim 14, wherein the fluoride concentration is more than two times greater than the control fluoride concentration.

16. The method of claim 1, wherein the dispensed composition has a faster foam generation during a first 30 seconds of brushing compared to the control dispensed composition.

17. A method for using an oral care composition comprising:
dispensing the oral care composition through a nozzle to form a dispensed composition, wherein the nozzle comprises:
an orifice having a central axis and an orifice diameter; and
fins partially occluding the orifice;
adding the dispensed composition to a liquid; and
forming a slurry of the dispensed composition and the liquid,
wherein the dispensed composition has a faster ion release in the slurry compared to a control dispensed composition made by dispensing the oral care composition through a control nozzle comprising an unobstructed, circular orifice having the orifice diameter.
